(19) United States
(12) Patent Application Publication
(10) Pub. No.: US 2006/0023359 A1
(43) Pub. Date: Feb. 2, 2006

(54) Head, head suspension assembly, and disc device provided with the same

(75) Inventor: Koji Matsushita, Kokubunji-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/181,812

(22) Filed: Jul. 15, 2005

(30) Foreign Application Priority Data
Jul. 30, 2004 (JP) 2004-224022

(51) Int. Cl. G11B 5/60

(52) U.S. Cl. 360/235.7; 360/236.2

(57) ABSTRACT

A head includes a slider, configured to fly by an air current produced between a surface of a recording medium and a facing surface of the slider, and a head portion which is provided on the slider and records and reproduces information on and from the recording medium. The slider has a negative-pressure cavity, and a pad portion, which is situated on the downstream side of the negative-pressure cavity with respect to the air current, protrudes from the facing surface. Read/write gaps of the head portion are formed in a projected surface of the pad portion. The pad portion has a step portion which is provided on the downstream side of the read/write gaps with respect to the air current and formed extending in a plurality of tiers from the projected surface in the direction of the air current.

### CROSS-REFERENCE TO RELATED APPLICATIONS

This application is based upon and claims the benefit of priority from prior Japanese Patent Application No. 2004-224022, filed Jul. 30, 2004, the entire contents of which are incorporated herein by reference.

### BACKGROUND OF THE INVENTION

1. Field of the Invention

This invention relates to a head used in a disk device, such as a magnetic disk device, a head suspension assembly provided with the head, and the disk device provided with the head suspension assembly.

2. Description of the Related Art

A magnetic disk device as a typical disk device comprises magnetic disks located in a case, a spindle motor that supports and rotates the disks, magnetic heads for reading and writing information from and to the disks, and a carriage assembly that supports the heads for movement with respect to the disks. The carriage assembly is provided with rotatably supported arms and suspensions that extend from the arms. The magnetic heads are supported individually on the respective extended ends of the suspensions. Each magnetic head has a slider mounted on its corresponding suspension and a head portion on the slider. The head portion includes a reproducing element and a recording element that are used to read and write information.

The slider has a facing surface that faces a recording surface of the magnetic disk. The slider is subjected by the suspension to a given head load that is directed toward a magnetic recording layer of the magnetic disk. When the magnetic disk device is actuated, an air current is produced between the rotating disk and the slider. Based on the principle of air fluid lubrication, a force to fly the slider above the recording surface of the disk acts on the facing surface of the slider. By balancing this flying force and the head load, the slider can fly with a given gap above the recording surface of the magnetic disk.

The fly of the slider is found to be uniform without regard to the radial position on the magnetic disk. The rotational frequency of the disk is fixed, and its peripheral speed varies depending on the radial position. Since the magnetic head is positioned by a rotary carriage assembly, moreover, the skew angle (angle between the direction of the air current and the center line of the slider) also varies depending on the radial position on the disk. In designing the slider, therefore, change of the fly that depends on the radial disk position must be restrained by suitably utilizing the aforesaid two parameters that vary depending on the radial disk position.

In consideration of the change of the working environment, the disk device is expected to operate smoothly in a low-pressure highland environment. If the magnetic head is constructed in consideration of only the balance between the head load and a positive pressure that acts on the facing surface of the slider based on the air fluid lubrication, the positive pressure that is generated by the air fluid lubrication is lowered in the low-pressure environment. Inevitably, therefore, the slider is balanced in a position where the fly is reduced or the slider touches the magnetic disk surface.

Described in Jpn. Pat. Appln. KOKAI Publication No. 2001-283549, for example, is a disk device in which a negative-pressure cavity is formed near the center of a facing surface of a slider in order to prevent a reduction of the fly. The negative-pressure cavity is defined by a groove that is surrounded by projected rails in three other directions than an air outlet direction. The slider is configured to fly on the balance between a negative pressure generated by the negative-pressure cavity, a head load, and a positive pressure. In a low-pressure environment, according to this configuration, the negative pressure is also reduced as the generated positive pressure is reduced. Thus, the slider can be realized having less reduction in fly. A head portion is formed on a center pad that is formed on the facing surface of the slider.

Thus, the flying posture, and decompressed fly reduction of the slider can be adjusted by suitably arranging an irregular shape of the facing surface of the slider. The irregular shape of the facing surface is formed of a groove of a single or several depths in consideration of the manufacturing cost.

Usually, a lubricant for lubrication is spread on the surface of the magnetic disk. Moving parts in a magnetic disk device are supplied with an oil constituent of, for example, grease for use as the lubricant. If the magnetic disk rotates at high speed during the operation of the disk device, the lubricant or oil constituent adheres to the facing surface of the slider, and collects and gradually grows on the rails and a rear edge of the center pad. In this case, the lubricant or oil constituent sticks to read/write parts of the magnetic head, thereby lowering the information processing capacity of the magnetic head. At the same time, the adhering oil constituent may possibly change the flying behavior of the magnetic head, thereby hindering steady recording and reproduction. Thus, the device somewhat lacks reliability.

### BRIEF SUMMARY OF THE INVENTION

According to an aspect of the invention, there is provided a head comprising: a slider having a facing surface opposed to a surface of a rotatable recording medium and configured to fly by an air current produced between the surface of the recording medium and the facing surface as the recording medium rotates; and a head portion which is provided on the slider and records and reproduces information on and from the recording medium. The slider has a negative-pressure cavity, which is defined by a recess in the facing surface and generates a negative pressure, and a pad portion, which is situated on a downstream side of the negative-pressure cavity with respect to the air current, protrudes from the facing surface, and has a projected surface facing the recording medium. The head portion has read/write gaps formed in the projected surface of the pad portion, and the pad portion having a step portion which is provided on the downstream side of the read/write gaps with respect to the air current and formed extending in a plurality of tiers from the projected surface in the direction of the air current.

According to another aspect of the invention, there is provided a head suspension assembly having a disk-shaped recording medium and a drive unit which supports and rotates the recording medium and used in a disk device, the head suspension assembly comprising: a head including a slider, having a facing surface opposed to a surface of the recording medium and configured to fly by an air current produced between the surface of the recording medium and the facing surface as the recording medium rotates, and a head portion which is provided on the slider and records and reproduces information on and from the recording medium; and a head suspension which supports the head for movement with respect to the recording medium and applies a head load directed toward the recording medium surface to the head. The slider has a negative-pressure cavity, which is defined by a recess in the facing surface and generates a negative pressure, and a pad portion, which is situated on a downstream side of the negative-pressure cavity with respect to the air current, protrudes from the facing surface, and has a projected surface facing the recording medium. The head portion has read/write gaps formed in the projected surface of the pad portion, and the pad portion has a step portion which is provided on the downstream side of the read/write gaps with respect to the air current and formed extending in a plurality of tiers from the projected surface in the direction of the air current.

According to an aspect of the invention, there is provided a disk device comprising: a disk-shaped recording medium; a drive unit which supports and rotates the recording medium; a head including a slider, having a facing surface opposed to a surface of the recording medium and configured to fly by an air current produced between the surface of the recording medium and the facing surface as the recording medium rotates, and a head portion which is provided on the slider and records and reproduces information on and from the recording medium; and a head suspension which supports the head for movement with respect to the recording medium and applies a head load directed toward the recording medium surface to the head.

The slider has a negative-pressure cavity, which is defined by a recess in the facing surface and generates a negative pressure, and a pad portion, which is situated on a downstream side of the negative-pressure cavity with respect to the air current, protrudes from the facing surface, and has a projected surface facing the recording medium. The head portion has read/write gaps formed in the projected surface of the pad portion, and the pad portion has a step portion which is provided on the downstream side of the read/write gaps with respect to the air current and formed extending in a plurality of tiers from the projected surface in the direction of the air current.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view showing a hard disk drive (HDD) according to an embodiment of the invention;

FIG. 2 is an enlarged side view showing a magnetic head portion of the HDD;

FIG. 3 is a perspective view showing the disk-facing surface side of a slider of the magnetic head;

FIG. 4 is an enlarged perspective view showing a center pad portion of the slider; and

FIG. 5 is an enlarged side view showing a flying state of the magnetic head.

### DETAILED DESCRIPTION OF THE INVENTION

An embodiment in which a disk device according to this invention is applied to an HDD will now be described in detail with reference to the accompanying drawings.

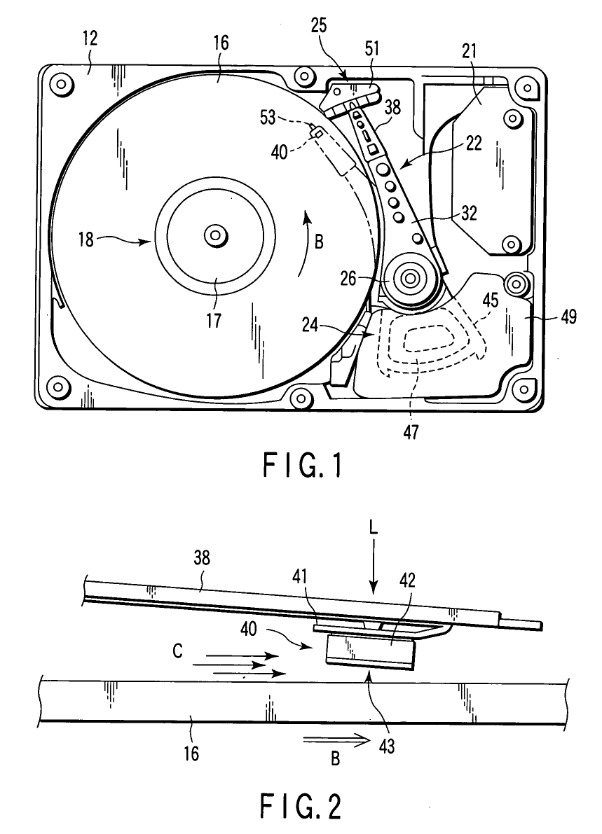

As shown in FIG. 1, the HDD comprises a case 12 in the form of an open-topped rectangular box and a top cover (not shown). The top cover is screwed to the case with screws and closes a top opening of the case.

The case 12 contains a magnetic disk 16 for use as a recording medium, a spindle motor 18, magnetic heads, and a carriage assembly 22. The spindle motor 18 serves as a drive unit that supports and rotates the disk. The magnetic heads are used to write and read information on and from the disk. The carriage assembly 22 supports the magnetic heads for movement with respect to the magnetic disk 16. The case 12 further contains a voice coil motor (VCM) 24, a ramp load mechanism 25, a board unit 21, etc. The VCM 24 rocks and positions the carriage assembly. The ramp load mechanism 25 holds the magnetic heads in a shunt position off the magnetic disk when the heads are moved to the outermost periphery of the disk. The board unit 21 has a head IC and the like.

A printed circuit board (not shown) is screwed to the outer surface of a bottom wall of the case 12. This circuit board controls the respective operations of the spindle motor 18, VCM 24, and magnetic heads through the board unit 21.

The magnetic disk 16 has magnetic recording layers on its upper and lower surfaces, individually. The disk 16 is fitted on the outer periphery of a hub (not shown) of the spindle motor 18 and fixed on the hub by a clamp spring 17. As the motor 18 is driven, the disk 16 is rotated at a given speed of, e.g., 4,200 rpm, in the direction of arrow B.

The carriage assembly 22 comprises a bearing assembly 26 fixed on the bottom wall of the case 12 and arms 32 that extend from the bearing assembly. These arms 32 are situated parallel to the surface of the magnetic disk 16 and spaced from one another. They extend in the same direction from the bearing assembly 26. The carriage assembly 22 is provided with suspensions 38 that are formed of an elastically deformable elongated plate spring each. The suspensions 38 have their respective proximal ends fixed to the respective distal ends of the arms 32 by spot welding or adhesive bonding and extend from the arms. Each suspension 38 may be formed integrally with its corresponding arm 32. The arms 32 and the suspensions 38 constitute a head suspension. The head suspension and the magnetic heads constitute a head suspension assembly.

As shown in FIG. 2, each magnetic head 40 has a substantially rectangular slider 42 and a head portion 44 for recording and reproduction on the slider. It is fixed to a gimbals spring 41 that is provided on the distal end portion of the suspension 38. A head load L that is directed toward the surface of the magnetic disk 16 is applied to each magnetic head 40 by the elasticity of the suspension 38.

As shown in FIG. 1, the carriage assembly 22 has a support frame 45 that extends from the bearing assembly 26 in a direction opposite from the arms 32. This support frame supports a voice coil 47 that constitutes a part of the VCM 24. The support frame 45 is molded integrally from synthetic resin on the outer periphery of the coil 47. The voice coil 47 is situated between a pair of yokes 49 that are fixed on the case 12. The coil 47, along with the yokes and a magnet (not shown) fixed to one of the yokes, constitutes the VCM 24. If the voice coil 47 is energized, the carriage assembly 22 rocks around the bearing assembly 26, and the magnetic head 40 is moved to and positioned over a desired track of the magnetic disk 16.

The ramp load mechanism 25 comprises a ramp 51 and a tab 53. The ramp 51 is provided on the bottom wall of the case 12 and located outside the magnetic disk 16. The tab 53 extends from the distal end of each suspension 38. As the carriage assembly 22 rocks to a shunt position outside the magnetic disk 16, each tab 53 engages a ramp surface formed on the ramp 51. Thereafter, the tab 53 is pulled up by the inclination of the ramp surface, whereby the magnetic head is unloaded.

The following is a detailed description of the construction of the magnetic head 40. As shown in FIGS. 2 to 5, the slider 42 of the magnetic head 40 is substantially in the shape of a rectangular parallele-piped. The slider has a rectangular disk-facing surface 43 that faces a surface of the magnetic disk 16. The magnetic head 40 is constructed as a flying head. The slider 42 flies by an air current C that is produced between the disk surface and the disk-facing surface 43 as the magnetic disk 16 rotates. During the operation of the HDD, the disk-facing surface 43 of the slider 42 never fails to face the disk surface with a gap between them. The direction of the air current C is coincident with the rotation direction B of the magnetic disk 16.

The slider 42 is located with respect to the surface of the magnetic disk 16 so that the longitudinal direction of the disk-facing surface 43 is substantially coincident with the direction of the air current C. A substantially U-shaped rail portion 46 protrudes from the disk-facing surface 43. The rail portion 46 is shaped so as to open on the downstream side of the air current C. It has a pair of straight portions 46a that extend individually along the long sides of the disk-facing surface 43 and a junction 46b that connects the respective upstream-side ends of the straight portions. The rail portion 46 has a substantially flat bottom surface that faces the surface of the magnetic disk 16. The rail portion 46 has a height of about 0.5 mm, and its peripheral surface is raised substantially upright on the disk-facing surface 43 without having any intermediate level difference.

A negative-pressure cavity 44 is formed in a substantially central part of the disk-facing surface 43. It is formed of a recess that is defined by the rail portion 46. The cavity 44 opens on the downstream side with respect to the direction of the air current C. The negative-pressure cavity 54, a recess, can generate a negative pressure in the central part of the disk-facing surface 43 for all skew angles that can be realized in the HDD. Further, a negative pressure ceases to be generated in the center of the slider, depending on the radial position on the magnetic disk 16, and the rolling angle of the slider 42 is widened, based on the radial direction.

The slider 42 has a center pad 50 substantially in the shape of a rectangular parallelepiped that protrudes from a downstream-side end portion of the disk-facing surface 43 with respect to the direction of the air current C. The center pad 50, which serves as a pad portion, is situated on the downstream side of the negative-pressure cavity 44 with respect to the direction of the air current C and substantially in the center of the disk-facing surface 43 with respect to the transverse direction. The height H of the center pad 50 is about 0.5 mm. The center pad 50 has a substantially rectangular projected surface 50a. The projected surface 50a faces the surface of the magnetic disk 16 and is situated substantially flush with the bottom surface of the rail portion 46.

A head portion 52 of the magnetic head 40 has a recording element and a reproducing element, which serve to record and reproduce information on and from the magnetic disk 16, respectively. The recording and reproducing elements are provided in a downstream-side end portion of the slider 42 with respect to the direction of the air current C. The reproducing and recording elements have read/write gaps 54 formed in the projected surface 50a of the center pad 50.

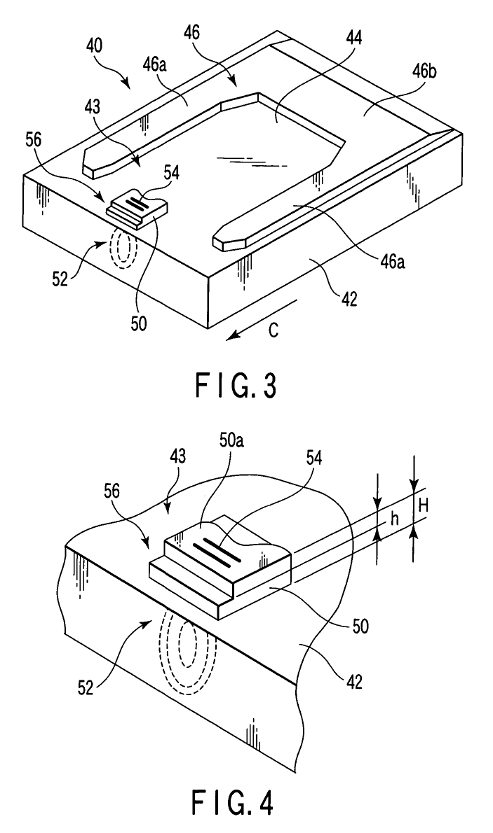

As shown in FIGS. 3 to 5, the center pad 50 has a plurality of side faces that extend from a peripheral edge of the projected surface 50a to the disk-facing surface 43. Among these side faces, a side face that is directed toward the negative-pressure cavity 44 and a pair of side faces that extend parallel to the long sides of the slider 42 are raised substantially upright on the disk-facing surface 43 without having any level difference. A side face of the center pad 50 that is situated on the downstream side of the read/write gaps 54 with respect to the air current constitutes a step portion 56. The step portion 56 is formed extending in a plurality of tiers, e.g., two tiers, from the projected surface 50a to the disk-facing surface 43 in the direction of the air current C so that its height is reduced stepwise. Each level difference h of the step portion 56 ranges from 0.03 to 0.3 mm.

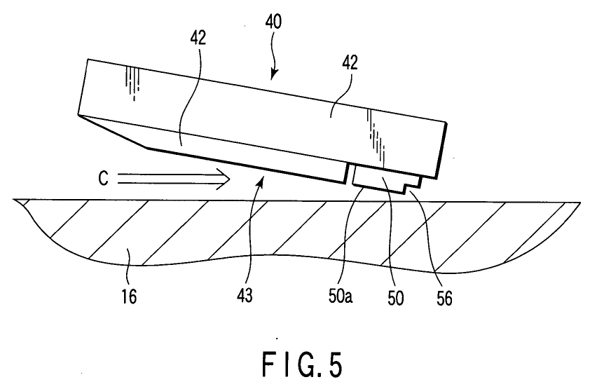

As shown in FIG. 5, the magnetic head 40 having the above-described construction flies in an inclined posture such that the read/write gaps 54 of the head portion 52 are situated closest to the disk surface.

According to the HDD and the head suspension assembly constructed in this manner, the magnetic head 40 flies by the air current C that is produced between the disk surface and the disk-facing surface 43 as the magnetic disk 16 rotates. Thus, during the operation of the HDD, the disk-facing surface 43 of the slider 42 never fails to face the disk surface with the gap between them. In this case, the pressure of the air current C that is produced between the disk surface and the disk-facing surface 43 gradually increases from the inlet side to the outlet side of the slider 42, that is, toward the downstream side. As the air current C passes through a downstream side end of the rail portion 46, it is suddenly released by the level difference of the rail portion so that its pressure lowers. Therefore, an oil constituent in the air current C suddenly changes from a gas phase into a liquid phase at the step portion of the rail portion 46 and adheres to and accumulates on the step portion.

On the other hand, the step portion 56 is provided on a downstream side end of the center pad 50 with respect to the direction of the air current C. As the air current C passes through the step portion 56, it is gradually released so that its pressure lowers gradually. Therefore, the oil constituent in the air current C gradually changes into a liquid phase without suddenly changing from a gas phase into a liquid phase. Thus, adhesion and accumulation of the oil constituent at the step portion 56 can be reduced considerably. In consequence, adhesion and accumulation of the oil constituent at the head portion 52 can be restrained.

According to the magnetic head 40, as described above, the step portion 56 serves to restrain the oil constituent from adhering to or accumulating on the center pad 50 that is provided with the read/write gaps 54 of the head portion 52, and positively to cause the oil constituent to adhere to and accumulate on any other portion, e.g., the step portion of the rail portion 46. Thus, adhesion of the oil constituent to the head portion 52 can be controlled effectively, and change of the flying behavior of the magnetic head and lowering of the information processing capacity can be prevented. In consequence, there may be provided the head, which ensures a steady fly and improved reliability, the head suspension assembly provided with the head, and the HDD.

This invention is not limited directly to the embodiment described above, and its components may be embodied in modified forms without departing from the scope or spirit of the invention. Further, various inventions may be made by suitably combining a plurality of components described in connection with the foregoing embodiment. For example, some of the components according to the foregoing embodiment may be omitted. Furthermore, components according to different embodiments may be combined as required.

The shapes and sizes of the rail portion and the center pad of the slider are not limited to those of the embodiment described above, but may be varied if necessary. The step portion of the center pad is not limited to a two-tier structure but may be a structure of three or more tiers. The number of magnetic disk(s) in the HDD is not limited to one but may be increased as required.

What is claimed is:

1. A head comprising:
a slider having a facing surface opposed to a surface of a rotatable recording medium and configured to fly by an air current produced between the surface of the recording medium and the facing surface as the recording medium rotates; and
a head portion which is provided on the slider and records and reproduces information on and from the recording medium,
the slider having a negative-pressure cavity, which is defined by a recess in the facing surface and generates a negative pressure, and a pad portion, which is situated on a downstream side of the negative-pressure cavity with respect to the air current, protrudes from the facing surface, and has a projected surface facing the recording medium,
the head portion having read/write gaps formed in the projected surface of the pad portion,
the pad portion having a step portion which is provided on the downstream side of the read/write gaps with respect to the air current and formed extending in a plurality of tiers from the projected surface in the direction of the air current.

2. The head according to claim 1, wherein each level difference of the step portion ranges from 0.03 to 0.3 mm.

3. The head according to claim 1, which further comprises a rail portion protruding from the facing surface so as to surround the negative-pressure cavity, the rail portion having a bottom surface opposed to the recording medium surface and a peripheral surface raised from the bottom surface to facing surface.

4. A head suspension assembly having a disk-shaped recording medium and a drive unit which supports and rotates the recording medium and used in a disk device, comprising:
a head including a slider, having a facing surface opposed to a surface of the recording medium and configured to fly by an air current produced between the surface of the recording medium and the facing surface as the recording medium rotates, and
a head portion which is provided on the slider and records and reproduces information on and from the recording medium; and
a head suspension which supports the head for movement with respect to the recording medium and applies a head load directed toward the recording medium surface to the head,
the slider having a negative-pressure cavity, which is defined by a recess in the facing surface and generates a negative pressure, and a pad portion, which is situated on a downstream side of the negative-pressure cavity with respect to the air current, protrudes from the facing surface, and has a projected surface facing the recording medium,
the head portion having read/write gaps formed in the projected surface of the pad portion,
the pad portion having a step portion which is provided on the downstream side of the read/write gaps with respect to the air current and formed extending in a plurality of tiers from the projected surface in the direction of the air current.

5. The head suspension assembly according to claim 4, wherein each level difference of the step portion ranges from 0.03 to 0.3 mm.

6. The head suspension assembly according to claim 4, which further comprises a rail portion protruding from the facing surface so as to surround the negative-pressure cavity, the rail portion having a bottom surface opposed to the recording medium surface and a peripheral surface raised from the bottom surface to facing surface.

7. A disk device comprising:
a disk-shaped recording medium;
a drive unit which supports and rotates the recording medium;
a head including a slider, having a facing surface opposed to a surface of the recording medium and configured to fly by an air current produced between the surface of the recording medium and the facing surface as the recording medium rotates, and a head portion which is provided on the slider and records and reproduces information on and from the recording medium; and
a head suspension which supports the head for movement with respect to the recording medium and applies a head load directed toward the recording medium surface to the head,
the slider having a negative-pressure cavity, which is defined by a recess in the facing surface and generates a negative pressure, and a pad portion, which is situated on a downstream side of the negative-pressure cavity with respect to the air current, protrudes from the facing surface, and has a projected surface facing the recording medium,
the head portion having read/write gaps formed in the projected surface of the pad portion,
the pad portion having a step portion which is provided on the downstream side of the read/write gaps with respect to the air current and formed extending in a plurality of tiers from the projected surface in the direction of the air current.

8. The disk device according to claim 7, wherein each level difference of the step portion ranges from 0.03 to 0.3 mm.

9. The disk device according to claim 7, which further comprises a rail portion protruding from the facing surface so as to surround the negative-pressure cavity, the rail portion having a bottom surface opposed to the recording medium surface and a peripheral surface raised from the bottom surface to facing surface.
